(19) United States
(12) Patent Application Publication
(10) Pub. No.: US 2008/0063907 A1
(43) Pub. Date: Mar. 13, 2008

(54) Modules of solid oxide fuel cell and their operation methods

(76) Inventors: Shin Takahashi, Hitachi (JP); Hiromi Tokoi, Tokai (JP); Akira Gunji, Hitachinaka (JP); Tomoya Murota, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/657,693

(22) Filed: Jan. 25, 2007

(30) Foreign Application Priority Data
Sep. 12, 2006 (JP) 2006-246604

(51) Int. Cl. H01M 8/04

(52) U.S. Cl. 429/14; 429/24

(57) ABSTRACT

A module of solid oxide fuel cells, which is capable of making a temperature distribution of the module uniform, is composed of a plurality of fuel cells which are assembled together, and is adapted to be capable of controlling gas temperatures and/or gas flow rates of gasses fed into a center part and a peripheral part of the module, independent from each other. With this configuration, when the temperature of the center part of the module becomes higher than that of the peripheral part of the module during a temperature rise, the temperature or the flow rate of the gas fed into the center part of the module is controlled so as to restrain the temperature of the center part of the module from being increasing. Further, when the temperature of the center part of the module becomes higher than that of the peripheral part thereof during power generation, the temperature of the gas fed into the center part of the module is lowered, or the flow rate thereof is adjusted in order to restrain the center part of the module from increasing its temperature, whereby it is possible to make the temperature distribution of the module uniform.

### BACKGROUND OF THE INVENTION

1. Field of the Invention

The present invention relates to a module of solid oxide fuel cells and also relates to an operation method thereof.

2. Description of Related Art

A fuel cell is composed of an anode and a cathode between which an electrolyte is interposed, and is adapted to feed a fuel gas on the anode side and a gas oxidizer (usually air) on the cathode side so as to allow the fuel and the oxidizer to electrochemically react with each other through the electrolyte in order to generate an electric power. Thus, the fuel cell has a roll of a power plant. Of various kind of fuel cells, a solid oxide fuel cell has a high operating temperature in a range of about 700 to 1,000 deg. C., with a high degree of power generation efficiency, and can simply make use of waste heat. Thus, the solid oxide fuel cell has been prosperously studied and developed up to now.

Usually, several ten to several hundreds of fuel cells are laminated so as to constitute an assembly (a module) for obtaining a desired electric output power. In general, the module is heated for power generation up to a predetermined temperature at which the power generation is possible, by an external heat source such as a burner or a heater. During power generation, the cells generate heat due to Joule heat, and accordingly, it is operated in a thermally self-sustaining manner. Thus, no external heat source is required any further. However, should the module be subjected to a temperature distribution during a temperature rise, the cells would be broken due to thermal stress. Accordingly, it is required make the temperature distribution uniform during the temperature rise. Further, even during power generation, should the operation temperature of the cells be excessively low, they could not full exhibit their performance, and on the contrary, should the operation temperature be excessively high, the material thereof would deteriorate, resulting in a shortened service life. Thus, it is desired to operate the fuel cells in an optimum temperature range while the temperature distribution is made to be uniform as possible as it can. As a result, it is desired to make the temperature distribution of the module uniform either during the temperature rise or during the power generation, in view of the reliability, the performance and the service life of the module.

As to the uniform temperature distribution of the module, there have been known such examples that a gas feed pipe is arranged at the center of the module so as to simply cool the center part of the module (Refer to, for example, JP-A-2005-158530, paragraph 0058), or several air feed pipes are arranged in the center part of the module so as to feed the gas fed to the center part thereof at a higher flow rate (Refer to, for example, JP-A-2006-54175, Abstract).

### SUMMARY OF THE INVENTION

However, as to the prior art as stated above, both flow rate and temperature of gases to be fed cannot be controlled, independent from one another. Thus, for example, in the case of increasing the temperature of the module by a heated gas during, for example, the temperature rise, if the gas is fed into the module from an air chamber, a high temperature gas is preferentially fed in the center part of the module by a large quantity, and accordingly, the temperature of the center part of the module rises up, resulting in occurrence of a problem of temperature distribution.

Accordingly, an object of the present invention is to provide a module of solid oxide fuel cells capable of having a uniform temperature distribution either during temperature rise or during power generation, and as well, an operation method thereof.

To the end, according, to the present invention, there is provided a module of solid oxide fuel cells which are assembled with one other, characterized in that a flow rate and a gas temperature of an anode gas and/or a cathode gas fed to the center part of the module, and/or an anode gas and/or a cathode gas fed to a peripheral part of the module are controlled, independent from each other.

Further, according to the present invention, there is provided a module of solid oxide fuel cells, comprises a gas manifold for feeding a gas as an anode gas or a cathode gas to the module, in order to feed and distribute the gas from the manifold into the center part and the peripheral part of the module, characterized in that temperatures or flow rates of gas fed to the center part of the module and the peripheral part of the module are controlled, independent from each other.

Further, according to the present invention, there is provided a method of operating a module of solid oxide fuel cells, in which an anode gas and a cathode gas are fed to a module including an assembly of solid oxide fuel cells, characterized in that temperatures of a center part and a peripheral part of the module are measured, and a temperature and/or a flow rate of a gas fed to at least one of a gas fed to the center part of the module and a gas fed to the peripheral part of the module is controlled.

With the configuration of the present invention, since the temperatures or the flow rates of the gases fed to the center part and the peripheral part of the module can be controlled, independent from each other, the center part of the module can be effectively cooled every time during temperature rise and during power generation, whereby it is possible to make the temperature distribution uniform.

Other objects, features and advantages of the present invention will be apparent in view of the following description of embodiments of the present invention with reference to the accompanying drawings:

### BRIEF DESCRIPTION OF THE DRAWING

FIG. 1A is a schematic view illustrating a configuration of an embodiment of a module of solid oxide fuel cells according to the present invention,

FIG. 1B is a sectional view taken along line IB-IB in FIG. 1A;

FIG. 2A is a schematic view illustrating a configuration of a module of solid oxide fuel cells, which have been used in general;

FIG. 2B is a sectional view taken along line IIB-IIB in FIG. 2A;

FIG. 3 is a view illustrating a configuration of a single cell; and

FIG. 4 is a schematic view illustrating a configuration of another embodiment of the present invention.

### DETAILED DESCRIPTION OF THE INVENTION

According to the present invention, a temperature and a flow rate of a gas fed to a center part of a module, and those of a gas fed to a peripheral part of the module can be controlled, independent from each other. Accordingly, when the temperature of the center part of the module becomes high in comparison with that of the peripheral part during temperature rise the temperature or the flow rate of the gas fed to, for example, the center part can be controlled so as to restrain temperature rise of the center part. Further, the temperature of the center part of the module becomes high in comparison with that of the peripheral part thereof the temperature of the gas fed to, for example, the center part can be lowered or the flow rate thereof can be adjusted so as to restrain the temperature rise of the center part. It should be construed in the present application that the wording “A and/or B” gives meaning of all cases including both A and B, only A and only B.

Upon implementation of the present invention, it is desirable to provide a plurality of gas supply ports through a part of which a gas is fed into the center part of the module, and through the remainder of which a gas is fed to the entire module or the peripheral part of the module. It is preferable to control the temperatures and flow rates of the gassed fed from the gas supply ports, independent from each other.

Further, upon implementation of the present invention, it is desirable to provide a control unit for controlling a temperature or a flow rate of the gas fed from a plurality of the gas supply ports. The control unit is preferably the one which transmits a control signal in accordance with detection signals indicating both temperatures of the peripheral part of the module and the center part of the module. Accordingly, it is preferable to provide a temperature detector for detecting a temperature of the peripheral part of the module, and a temperature detector for detecting a temperature of the center part of the module. Further, it is preferable to incorporate a system control unit for transmitting a control signal to the control unit when it receives detection signals from the temperature detectors.

Further, upon implementation of the present invention, it is desirable to provide a manifold for distributing and supplying an anode gas and a cathode gas so as to supply the gases to the cells of the modules by way of the manifold. With the provision of, for example, a heater in a part of the module, the gas fed to the peripheral part of the module can be fed after the temperature of the gas is raised, and as well, the temperature of the center part of the module can be restrained from becoming excessively high.

In the case of the provision of the manifold, it is preferable to allow the manifold to have a plurality of gas supply ports through a part of which a gas is fed to the center part of the module, and through the remainder of which a gas is fed to the entire module or the peripheral part thereof so as to enable the temperatures and the flow rates of the gases fed from the plurality of gas supply ports to be controlled, independent from one other. Due to this reason, it is preferable to extend a part of the plurality of gas supply ports up to a center part of the manifold so as to smoothly feed the gas into the center part of the module. Further, it is desirable to provide partition plates in the manifold in order to feed a gas surrounded by the partition plates into the center part of the module.

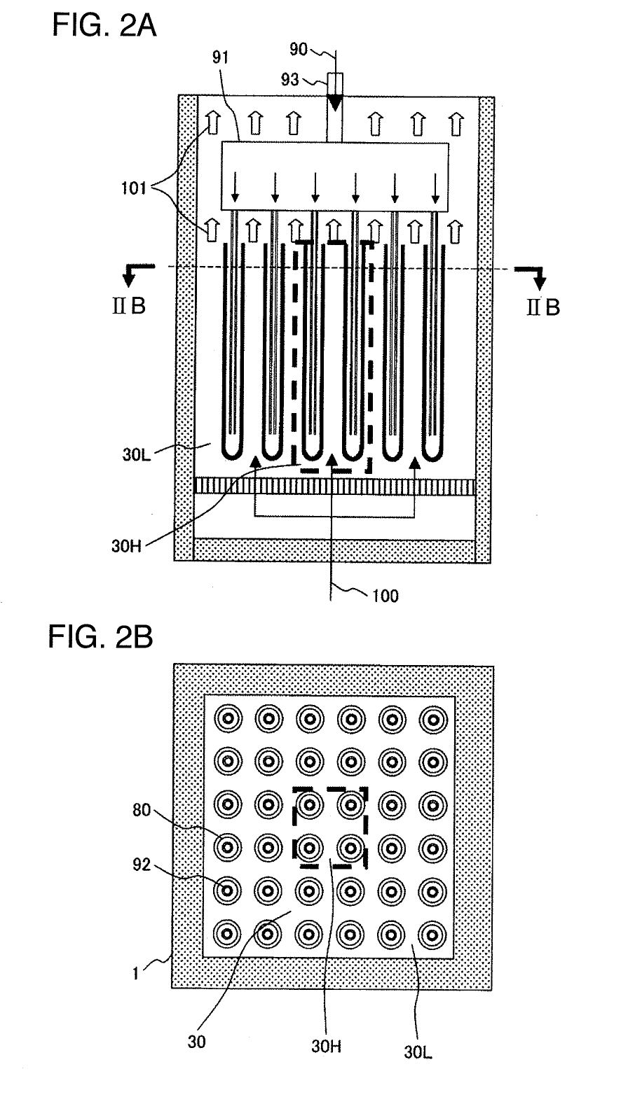

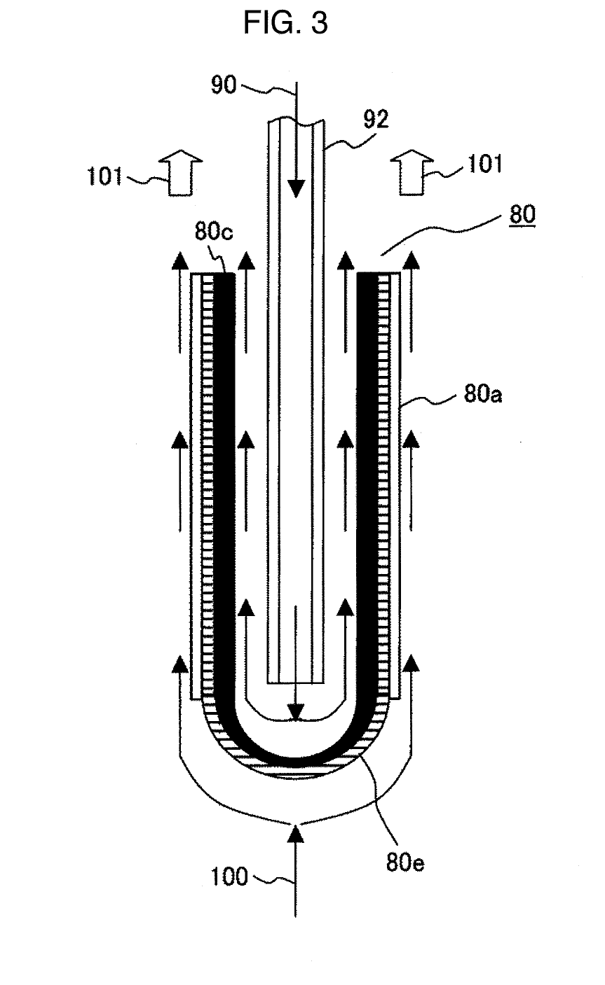

For the purpose of comparison with the present invention, there is shown a configuration of a common module of solid oxide fuel cells in FIGS. 2A and 2B in which FIG. 2A is a schematic sectional view illustrating an entire configuration of the module, and FIG. 2B is a sectional view taken along line IIB-IIB in FIG. 2A. A solid oxide fuel cell 80 as shown in FIG. 3 which is an enlarged view, comprises a solid oxide electrolyte 80e having a bottomed cylindrical shape, and an anode 80a and a cathode 80c which are provided respectively outside and inside of the electrolyte 80e. It is noted that the module having 36 solid oxide fuel cells 80 is shown in FIGS. 2A and 2B due to a convenient reason. However, the module usually has cells in a number from several tens to several hundreds which are laminated and assembled and which are arranged in series or in parallel for power generation. The assembly of cells as stated above will be referred to as a module 30.

An oxidizer gas (air or combustion gas) as the cathode gas is fed to the cathode side of the solid oxide fuel cell 80. This gas is fed from a gas supply port 93, through a header 91 serving the manifold for uniformly distributing the gas among the cells, and then through an air feed tube 92, to the cathode 80c.

Meanwhile, on the anode side of the cell 80, a gas which is usually a mixture of hydrocarbon fuel such as LNG, LPG or the like and steam, is in part or in all subjected to steam reforming in a reformer, and thereafter is fed thereto as the anode gas 100.

The cathode gas 90 and the anode gas 100, thus fed, cause electrochemical reaction for generation of an electric power and a heat. Unreacted gases in both cathode gas 90 and anode gas 100 are mixed and burnt on the outlet side of the solid oxide fuel cell 80 so as to be turned into a high temperature gas 101 which is heat-exchanged with the header 61 before it is exhausted. During a temperature rise, a high temperature gas which has been heated by the heater and an oxygen containing high temperature gas burnt in the burner are fed as the cathode gas to the cathode 80c in order to heat the module up to a temperature at which it can generate a power. During rated power generation, an air having a room temperature is fed as the cathode gas 90 so as to cool the heat caused by the electrochemical reaction of the solid oxide fuel cell 80 in order to aim at making the temperature uniform. During a partial load operation, since the heat caused by the electrochemical reaction is decreased, the heat of an exhaust gas 101 is used while the flow rate of the cathode gas 90 is decreased so as to preheat the cathode gas 90 more or less, and thereafter, the cathode gas 90 is fed to the cell. As stated above, the flow rate and the temperature of the cathode gas 90 to be fed are changed in accordance with an operating condition in order to control the temperature of the solid oxide fuel cell 80. Further, heat radiation is restrained by a heat insulator surrounding the module 30.

However, a peripheral part 30L of the module have had such a tendency that the cell temperature thereof is lower than that of the center part 30H thereof by a value corresponding to a heat radiation. Further, as the number of the cells are increased for the purpose of increasing the size of the module, the temperature of the center part H of the module becomes excessively high, resulting in a risk of exceeding an optimum operating temperature range. Thus, heretofore, although it is necessary to cool the center part of the module 30H of the module, the flow rates and the temperatures of the cathode gas to be fed have not been able to be controlled, independent from one another. Thus, in the case of heating the module with a heated gas during a temperature rise, should the gas is fed to the module from the air chamber, as disclosed in JP-A-2005-158530, a high temperature gas would be preferentially fed to the center part of the module by a large quantity so that the temperature of the center part of the module would be increased, resulting in a problem of occurrence of a temperature distribution. That is, in the conventional method, the temperature distribution of the module has been not uniform, and accordingly, the module has not be able to fully exhibit its performance. Further, there has been caused a problem of deteriorating its service life.

### Embodiment 1

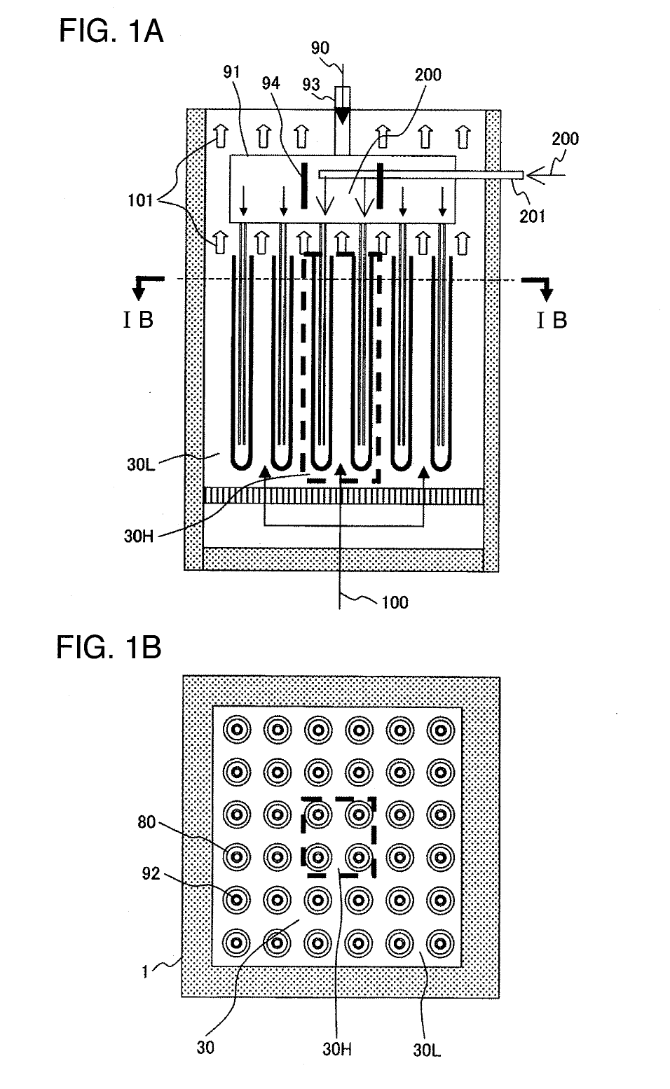

Referring to FIGS. 1A and 1B which show an embodiment of the present invention, in which FIG. 1A is a schematic sectional view illustrating an entire configuration of a module, and FIG. 1A is a sectional view taken along line A-A in FIG. 1A, in this embodiment, in addition to a first gas supply port 93, a header 90 is formed therein with a second gas supply port 201 so as to feed a cathode gas from these two gas supply ports. In this configuration, a heat-exchange value with exhaust gas 101 is decreased to that a cathode gas 200 fed from the second gas port 201 has a temperature which is lower than that of a cathode gas 90 fed from the gas port 93. Further, the gas supply port 201 is extended up to the center part of the header 91, and accordingly, the cathode gas 200 can preferentially cool the center part 30H of the module. In order to facilitate the supply of the cathode gas 200 into the center part of the module, partition plates 64 as shown in FIG. 1A may be provided. Since the partition plates 64 do not completely isolate the header 91, when the cathode gas 200 is not necessary, a gas is fed into the center part of the module by the cathode gas 90.

With this configuration, the flow rate and the temperature of the cathode gas fed to the header 61 can be controlled, independent from each other. For example, during a temperature rise, when a high temperature gas is fed from the gas supply port 93, if the temperature of the center part 30H of the module is increased, a low temperature cathode gas 200 is fed from the gas supply port 201 at a predetermined flow rate so as to restrain the center part 30H of the module from increasing its temperature. Further, during power generation, if the temperature of the center part 30H of the module is increased, a low temperature cathode gas 200 is similarly fed from the gas supply port 201 at a predetermined flow rate in order to restrain the temperature thereof from being increased.

That is, two gas supply ports are provided for the header 91, the flow rate and the temperature of the gas from each of them can be controlled, independent from each other, and accordingly, the center part 30H of the module is effectively cooled, whereby it is possible to achieve uniform temperature distribution.

### Embodiment 2

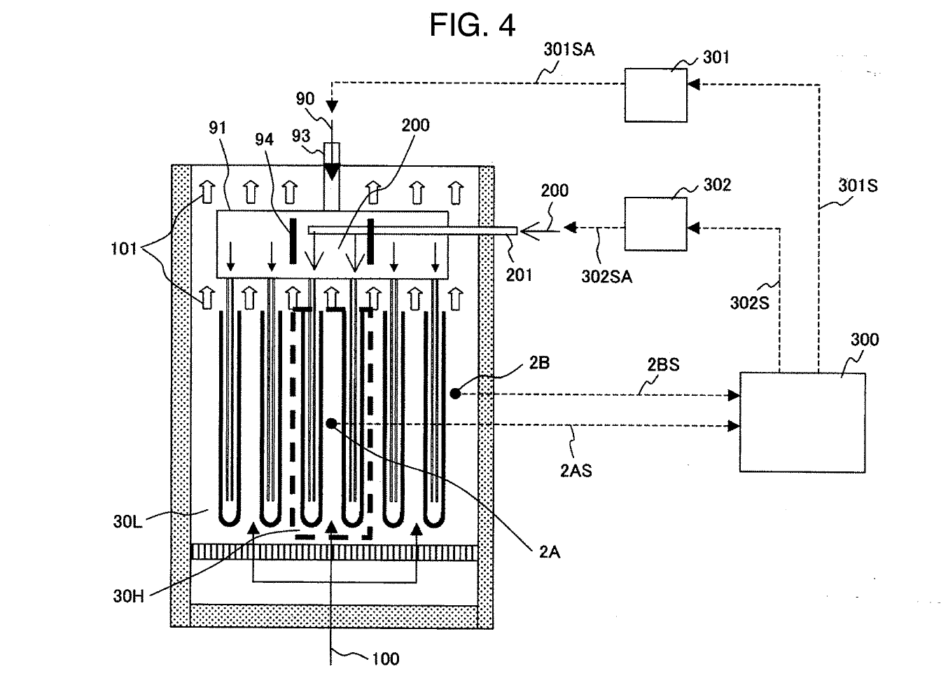

FIG. 4 shows a system for carrying out such a control that temperatures of the module are detected by means of a temperature sensor 2A provided in the center part 30H of the module and a temperature sensor 2B provided in the peripheral part 30L of the module, and are delivered as a detection signal 2AS and a detection signal 2BS to a system control unit 300. When data as to a temperature distribution of the module are delivered in the form of the detection signal 2AS and the detection signal 2BS from the temperature sensors 2A, 2B to the system control unit 300, the system control unit 300 therefore delivers a control signal 301S and a control signal 302S to a header control unit 301 and a header control unit 302, respectively. With the use of these control signals, during, for example, a temperature rise, the header control unit 301 controls the temperature and the flow rate of the cathode gas 90 fed from the gas supply port 93 in accordance with a control signal 301SA. Specifically, a temperature controlled by the heater and a burner combustion value is utilized. Further, the header control unit 302 initiates a supply of a low temperature cathode gas 200 from the gas supply port 201 in accordance with a control signal 302SA in order to feed a cooling gas into the center part of the module.

Even during power generation, the cathode gas 90 and the cathode gas 200 whose flow rates and temperatures are controlled in accordance with the detection signals from the temperature sensors 2A, 2B are fed from the header control units 301, 302 in order to reduce the temperature distribution of the module.

With the above-mentioned control the temperature distribution of the module can be made to be uniform. It is noted that although explanation has been made of the control, as an example, using the temperature sensors 2A, 2B, the essential feature of the present invention is the provision of such a configuration that a plurality of gas supply ports are provided in the header, gases having different flow rates and gas temperatures being fed into the gas supply ports, respectively, in order to aim at making the temperature distribution of the module uniform, and accordingly, the present invention should not be limited to this example.

Further, in this embodiment, although explanation has been made of the bottomed tubular cells as an example, the present invention may also be applied in the case of, for example, flat plate solid oxide fuel cells. Further, the header for cathode gas has been explained as a header applied thereto with the present invention, the present invention may also be similarly applied to a header for an anode gas.

Although the explanation has been made of the preferred embodiments of the present invention, the present invention should not be limited thereto, and various change and modifications are also made thereto without departing from the spirit of the present invention within the scope of the invention defined by the appended claims.

1. A module of solid oxide fuel cells which are assembled together, wherein a gas temperature or a gas flow rate of an anode gas and/or a cathode gas fed to a center part of the module, and a gas temperature or a gas flow rate of an anode gas and/or a cathode gas fed to a peripheral part of the module are controlled, independent from each other.

2. A module of solid oxide fuel cells as set forth in claim 1, wherein at least one of the anode gas and the cathode gas is fed into the module through a plurality of gas supply ports, a gas is fed into the center part of the module through a part of the gas supply ports, and a gas is fed into the entirety or the peripheral part of the module from the remainder of the gas supply ports.

3. A module of solid oxide fuel cells as set forth in claim 2, wherein there is provided a control unit for controlling gas temperatures and gas flow rates of gasses fed from the plurality of gas supply ports.

4. A module of solid oxide fuel cells as set forth in claim 3, wherein the control unit is adapted to deliver a control signal in accordance with detection signals indicating respectively a temperature of the peripheral part of the module and a temperature of the center part of the module.

5. A module of solid oxide fuel cells as set forth in claim 4, wherein there is provided a temperature detector for detecting a temperature of the peripheral part of the module, and a temperature detector for detecting a temperature of the center part of the module.

6. A module of solid oxide fuel cells as set forth in claim 5, wherein there is provided a system control unit which receives detection signals from the temperature detectors, and which delivers a control signal to the control unit.

7. A module of solid oxide fuel cells which are assembled together, wherein the module is provided with a distributor for distributing a gas fed as an anode gas or a cathode gas, among the cells so as to distribute and feed the gas into a center part and a peripheral part of the module by way of the distributor, and the temperatures or the flow rates of the gases fed to the center part and the peripheral part of the module are controlled, independent from each other.

8. A module of solid oxide fuel cells as set forth in claim 7, wherein the distributor incorporates a plurality of gas supply ports through a part of which a gas is fed into the center part of the module, and through the remainder of which a gas is fed into the entirety or the peripheral part of the module.

9. A module of solid oxide fuel cells as set forth in claim 8, wherein there is provided a control unit for controlling temperatures and flow rates of gasses fed from the plurality of gas supply ports.

10. A module of solid oxide fuel cells as set forth in claim 9, wherein the control unit delivers a control signal in accordance with a temperature of the peripheral part of the module and a temperature of the center part of the module

11. A module of solid oxide fuel cells as set forth in claim 10, wherein there is provided a temperature detector for detecting the peripheral part of the module, and a temperature detector for detecting the center part of the module.

12. A module of solid oxide fuel cells as set forth in claim 11, wherein there is provided a system control unit which delivers a control signal to the control unit which it receive detection signals from the temperature sensors.

13. A module of solid oxide fuel cells as set forth in claim 8, wherein the distributor is provided therein with partition plates for separating a gas adapted to be fed into the center part of the module from a gas adapted to be fed into the peripheral part of the module.

14. A method of operating a module of solid oxide fuel cells which are assembled together, for feeding an anode gas and a cathode gas into the module of solid oxide fuel cells so as to carry out power generation, the method comprising the steps of:
measuring temperatures of a center part and a peripheral part of the module; and
controlling a gas temperature and/or a gas flow rate of at least one of a gas fed into the center part of the module and a gas fed into the peripheral part of the module in accordance with the thus measured values.

15. A method of operating a module of solid oxide fuel cells as set forth in claim 14, wherein the gas whose gas temperature and/or flow rate are controlled is a cathode gas.

16. A method of operating a module of solid oxide fuel cells as set forth in claim 14, wherein the gas whose gas temperature and/or flow rate are controlled is an anode gas.
